(19) United States
(12) Patent Application Publication
(10) Pub. No.: US 2011/0203567 A1
(43) Pub. Date: Aug. 25, 2011

(54) Height adjusting assembly for a barbecue stove

(76) Inventor: Jui-Ju Yeh, Taipei (TW)

(21) Appl. No.: 12/660,303

(22) Filed: Feb. 24, 2010

(51) Int. Cl. A47J 37/07

(52) U.S. Cl. 126/25 A

(57) ABSTRACT

A height adjusting assembly for a barbecue stove has a grill pan, a handle rotatably mounted through the grill pan, a guiding panel securely attached to the handle, two rods pivotally mounted in the grill pan and two connectors respectively connected to the rods. The guiding panel has two arced guiding grooves. Two sliding pins respectively are mounted through the connectors and protrude in the guiding grooves of the guiding panel. When the handle is rotated, the connectors are pulled and move transversely, and the rods pivot to lower or raise a grate mounted on the rods. Thus, the grate departs from or approaches a grill rack. A distance between a heat source and foods is adjusted and heat applying to the foods is controlled.

### BACKGROUND OF THE INVENTION

1. Field of the Invention

The present invention relates to a height adjusting assembly for a barbecue stove, especially to a height adjusting assembly that supports a grate and adjusts a distance between the grate and a grill rack.

2. Description of the Prior Art(s)

A barbecue stove has a grill rack for placing foods, and a grate for placing a heat source, such as heated stones, lit coals or the like, underneath the grill rack.

However, different foods require different temperatures to cook thoroughly and temperature reduces with distance from the grate. Therefore, at a set distance some food will burn without cooking, some food will not cook and other food will dry out before cooking thoroughly. Further, when using exhausted heat sources, such as charcoal and coal, temperature also varies with time so different foods need to be cooked at different times.

Also, oil and juices from meat and marinades drop into the heat source and may be lit by the heat source causing irregular heat patches and ash to be kicked up and cover food.

To overcome the shortcomings, the present invention provides a height adjusting assembly for a barbecue stove to mitigate or obviate the aforementioned problems.

### SUMMARY OF THE INVENTION

The main objective of the present invention is to provide a height adjusting assembly for a barbecue stove. The height adjusting assembly has a grill pan, a handle rotatably mounted through the grill pan, a guiding panel securely attached to the handle, two rods pivotally mounted in the grill pan and two connectors respectively connected to the rods. The guiding panel has two arced guiding grooves. Two sliding pins are respectively mounted through the connectors and protrude in the guiding grooves of the guiding panel.

When the handle is rotated, the connectors are pulled and move transversely, and the rods pivot to lower or raise a grate. Thus, the grate departs from or approaches a food grill. A distance between a heat source and foods is adjusted and heat applying to the foods is controlled.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a height adjusting assembly for a barbecue stove in accordance with the present invention;

FIG. 2 is a perspective view of the height adjusting assembly in FIG. 1, a grill pan shown in phantom lines;

FIG. 3 is an exploded perspective view of the height adjusting assembly in FIG. 1, the grill pan shown in phantom lines;

FIG. 4 is an operational rear view of the height adjusting assembly in FIG. 1, showing a grill lowered; and

FIG. 5 is another operational rear view of the height adjusting assembly in FIG. 1, showing the grill raised.

### DETAILED DESCRIPTION OF THE PREFERRED EMBODIMENTS

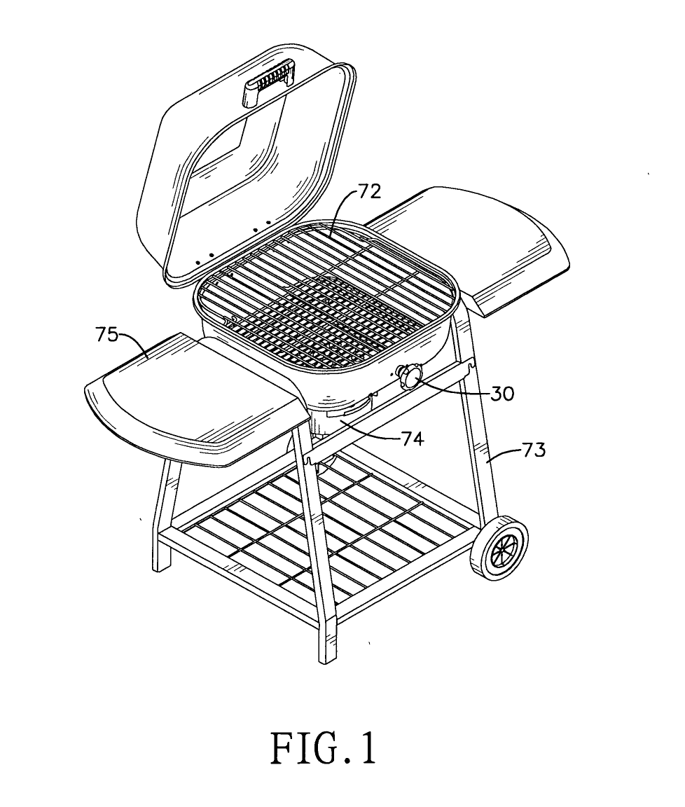

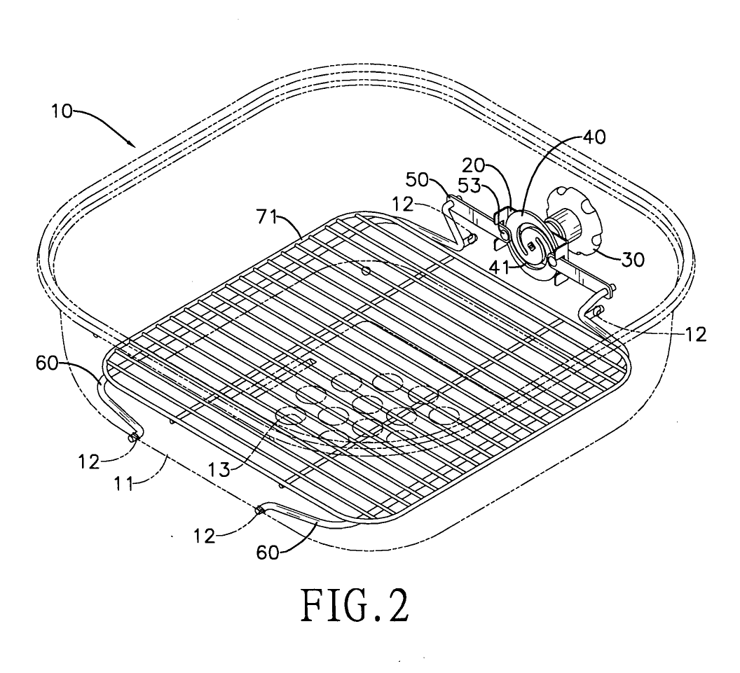

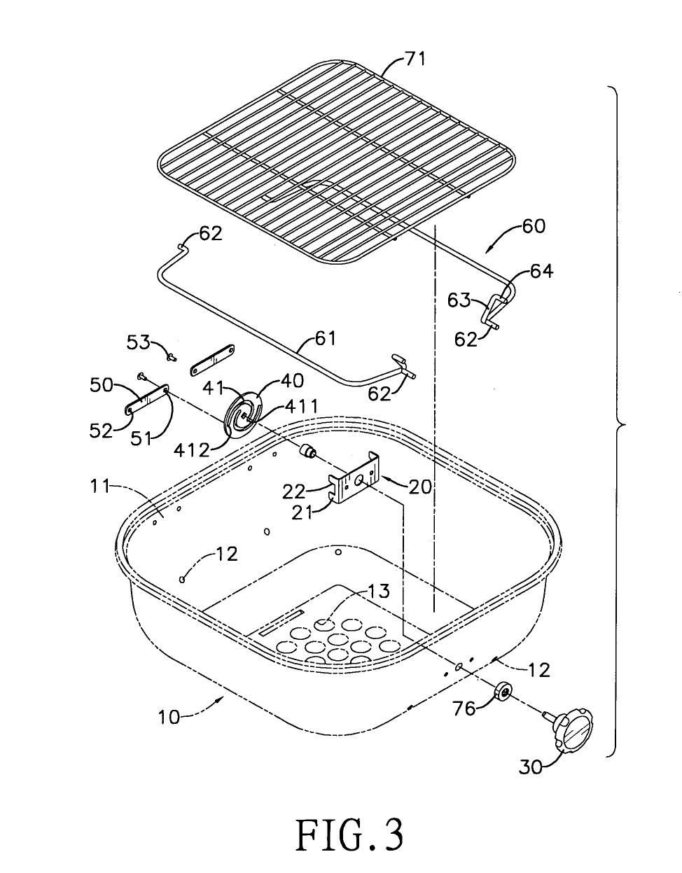

With reference to FIGS. 1 to 3, a height adjusting assembly for a barbecue stove in accordance with the present invention comprises a grill pan (10), a retaining bracket (20), a handle (30), a guiding panel (40), two connectors (50), two sliding pins (53) and two rods (60).

The grill pan (10) has a sidewall (11) and two pairs of sockets (12) and may have multiple through holes (13), a stand (73), an ash tray (74) and two trays (75). The sidewall (11) is formed around and protrudes up from a bottom of the grill pan (10). The pairs of sockets (12) are oppositely formed through the sidewall (11). The through holes (13) are formed through the bottom of the grill pan (10). The stand (73) is mounted on the grill pan (10) to support the grill pan (10). The ash tray (74) is mounted on the bottom of the grill pan (10) outside the grill pan (10) and corresponds to the through holes (13) for catching ash falling out through the through holes (13) of the grill pan (10). The trays (75) are respectively mounted on two opposite sides of the grill pan (10) outside the grill pan (10) for placing barbecue supplies.

The retaining bracket (20) is securely mounted on an inner surface of the sidewall (11) of the grill pan (10), may be disposed between the sockets (12) of a corresponding pair of sockets (12) and has two longitudinal sidewalls (21). Each longitudinal sidewall (21) has a retaining hole (22) formed through the longitudinal sidewall (21).

The handle (30) is rotatably mounted through a nut (76) and the sidewall (11) of the grill pan (10) from an exterior of the grill pan (10) to an interior of the grill pan (10) and may be rotatably mounted through the retaining bracket (20).

The guiding panel (40) is mounted in the grill pan (10), may be mounted between the longitudinal sidewalls (21) of the retaining bracket (20), is securely attached to the handle (30) and has two guiding grooves (41). The guiding grooves (41) are arced and are oppositely formed through the guiding panel (40). Each guiding groove (41) has an outer end (412) and an inner end (411). The outer end (412) is adjacent to a peripheral edge of the guiding panel (40). The inner end (411) is adjacent to a center of the guiding panel (40) and is disposed between the center of the guiding panel (40) and the outer end (412) of the other guiding groove (41).

The connectors (50) are mounted beside the guiding panel (40), may be elongated and may be transversely mounted respectively through the retaining holes (22) of the retaining bracket (20). Each connector (50) has a sliding end (51) and a connecting end (52).

The sliding pins (53) are respectively mounted through the sliding ends (51) of the connectors (50) and respectively protrude in the guiding grooves (41) of the guiding panel (40).

The rods (60) are pivotally mounted in the grill pan (10). Each rod (60) has an arced support (61), two pivoting protrusions (62) and a lever (63). The arced support (61) has two ends. The pivoting protrusions (62) respectively protrude from the ends of the arced support (61), are bent relative to the arced support (61), are parallel to each other and are pivotally mounted through the sidewall (11) of the grill pan (10). Each pivoting protrusion (62) is pivotally mounted through one socket (12) of a corresponding pair of sockets (12). The lever (63) protrudes from the pivoting protrusion (62) that corresponds to the guiding panel (40), is disposed inside the grill pan (10) and is pivotally connected to the connecting end (52) of a corresponding connector (50).

When the handle (30) is rotated, the guiding panel (40) rotates simultaneously and the sliding pins (53) move along the guiding grooves (41) of the guiding panel (40). Then the connectors (50) are pulled and move transversely, and the rods (60) pivot at the pivoting protrusions (62). Moreover, a grate (71) for placing a heat source, such as heated stones, lit coals or the like, is disposed on the arced supports (61) of the rods (60) and a grill rack (72) for placing foods is mounted on the grill pan (10) over the grate (71).

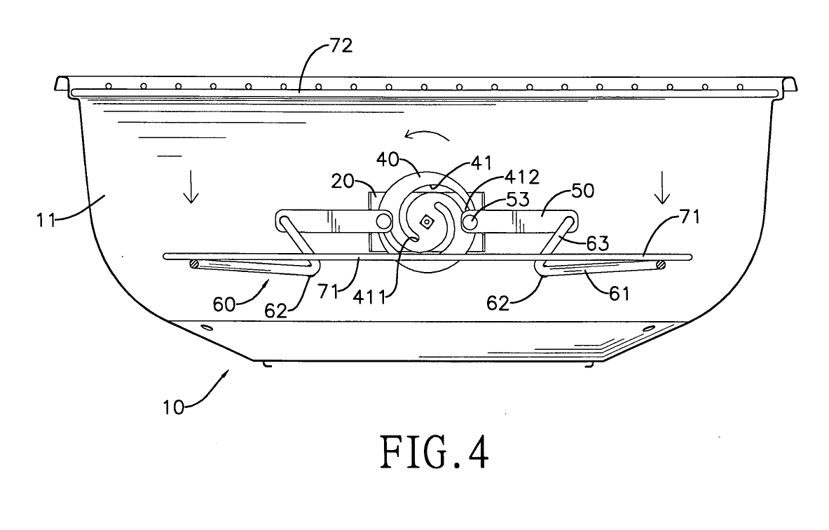

With further reference to FIG. 4, as the handle (30) rotates in a forward direction to force the sliding pin (53) to move toward the outer ends (412) of the guiding grooves (41), the connectors (50) depart from each other and the arced supports (61) of the rods (60) pivot downwardly. Thus, the grate (71) is lowered relative to the grill rack (72) and departs from the grill rack (72).

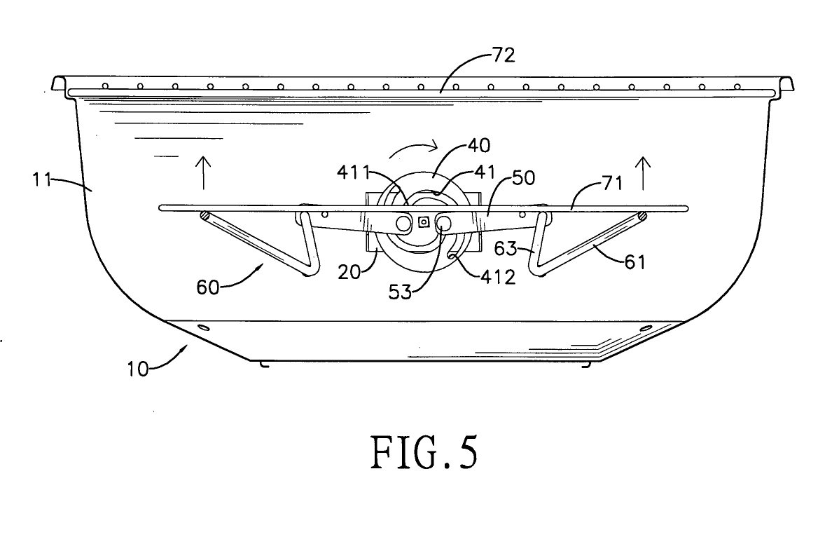

With further reference to FIG. 5, as the handle (30) rotates in a reverse direction to force the sliding pin (53) to move toward the inner ends (411) of the guiding grooves (41), the connectors (50) approach each other and the arced supports (61) of the rods (60) pivot upwardly. Thus, the grate (71) is raised relative to the grill rack (72) and approaches the grill rack (72).

The height adjusting assembly for the barbecue stove as described has the following advantages. The height adjusting assembly supports the grate (71) and holds the rods (60) to stop at specific positions. Therefore, a distance between the heat source and the foods is adjusted according to a temperature of the heat source, kinds of the foods or any other unexpected situations, and heat applying to the foods is controlled.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A height adjusting assembly for a barbecue stove comprising
a grill pan having a sidewall formed around and protruding up from a bottom of the grill pan;
a handle rotatably mounted through the sidewall of the grill pan from an exterior of the grill pan to an interior of the grill pan;
a guiding panel mounted in the grill pan, securely attached to the handle and having two guiding grooves being arced and oppositely formed through the guiding panel, and each guiding groove having
an outer end is adjacent to a peripheral edge of the guiding panel; and
an inner end being adjacent to a center of the guiding panel and being disposed between the center of the guiding panel and the outer end of the other guiding groove;
two connectors mounted beside the guiding panel, and each connector having a sliding end and a connecting end;
two sliding pins respectively mounted through the sliding ends of the connectors and respectively protruding in the guiding grooves of the guiding panel; and
two rods pivotally mounted in the grill pan, and each rod having
an arced support having two ends;
two pivoting protrusions respectively protruding from the ends of the arced support, bent relative to the arced support, being parallel to each other and pivotally mounted through the sidewall of the grill pan; and
a lever protruding from the pivoting protrusion that corresponds to the guiding panel, disposed inside the grill pan and pivotally connected to the connecting end of a corresponding connector.

2. The height adjusting assembly as claimed in claim 1 further comprising a retaining bracket securely mounted on an inner surface of the sidewall of the grill pan and having two longitudinal sidewalls, and each longitudinal sidewall having a retaining hole formed through the longitudinal sidewall;
the handle further mounted through the retaining bracket;
the guiding panel mounted between the longitudinal sidewalls of the retaining bracket; and
the connectors being elongated and transversely mounted respectively through the retaining holes of the retaining bracket.

3. The height adjusting assembly as claimed in claim 2, wherein the grill pan further has two pairs of sockets oppositely formed through the sidewall;
the retaining bracket is disposed between the sockets of a corresponding pair of sockets; and
each pivoting protrusion of each rod is pivotally mounted through one socket of a corresponding pair of sockets.
